(19) United States
(12) Patent Application Publication
(10) Pub. No.: US 2004/0247135 A1
(43) Pub. Date: Dec. 9, 2004

(54) Method and apparatus for multichannel logic matrix decoding

(76) Inventors: Roger Wallace Dressler, Danville, CA (US); Kenneth James Gundry, San Francisco, CA (US)

Correspondence Address: Gallagher & Lathrop, Suite 1111, 601 California Street, San Francisco, CA, 94108-2805, US

(21) Appl. No.: 10/490,234

(22) PCT Filed: Sep. 23, 2002
(86) PCT No.: PCT/IB02/03930

(30) Foreign Application Priority Data
Sep. 25, 2001 (US) 60325112

(51) Int. Cl. H04R 5/00

(52) U.S. Cl. 381/20

(57) ABSTRACT

The present invention improves the stability of aural images in the decoding of multichannel signals. Output center-channel and back-surround channel signals are derived or augmented by applying signal processors such as matrix decoders to multichannel input signals.

### TECHNICAL FIELD

The present invention generally pertains to audio signal processing and pertains more particularly to techniques for decoding multichannel signals.

### BACKGROUND ART

The music industry has used two-channel stereo for half a century. Typically, the main vocal signals (or other centrally located signals) are mixed equally into the left and right channels to create a center “phantom” image for listeners situated equidistant from the left- and right-channel loudspeakers.

A well recognized shortcoming of two-channel stereo listening is the collapse of the sound field as one moves away from the ideal central “sweet spot”. Central signals appear to come from the loudspeaker closest to the listener rather than from a point between the loudspeakers of the two channels. One known way of avoiding or reducing this problem is to use a third center channel; however, three-channel source material has not been very common.

Another known way to reduce this problem is to apply a logic matrix decoder to a two-channel source to derive one or more additional signals including a center channel signal. A Dolby Pro Logic decoder, for example, accepts two input signals and derives left (L), center (C), right (R) and surround (S) output signals. The Pro Logic II decoder derives L, C, R, left-surround (Ls) and right-surround (Rs) output signals from a two-channel source and is intended to work with either Dolby Surround encoded material or conventional stereo recordings.

It is well established that a key benefit of Pro Logic surround decoding is the center-channel output that improves the stability of central signal images for listeners seated off the central axis of the loudspeaker system. This benefit is equally available in the simpler 3-channel (L, C, R) matrix decoding system known as Dolby 3 Stereo. Applications for all the above decoders include both home and car audio systems.

A similar benefit may be obtained for surround channel signals by applying logic matrix decoders in multichannel systems such as those systems providing conventional 5 or 5.1-channel discrete source signals. In this application, which is called Surround EX, a logic matrix decoder is fed with the Ls and Rs signals of a 5-channel soundtrack to derive three surround channels (Ls, Bs, Rs) from the original two. FIG. 1 provides a block diagram of this application. Listeners seated off center are better able to sense the directional cues intended to come from between the Ls and Rs channel loudspeakers.

With the advent of DVD audio, 5.1-channel audio programs are becoming more commonplace. One might expect the problem with sound field collapse will be easily avoided with 5.1-channel systems because they provide a discrete center channel. Unfortunately, the problem will not be avoided because these systems afford additional flexibility in how vocal signals are mixed among the three front channels. In some cases, vocal signals are mixed as before, exclusively in the L/R channels, to create a phantom center image. In other cases, vocal signals are mixed into only the center channel. In yet other cases, vocal signals are mixed into all three front channels in varying proportions. While these mixing choices may affect the integration or clarity of the vocal signals, in most cases the vocals are intended to be perceived as emanating from the center of the soundstage. For those mixes that place vocal and other central signals into the L/R channels rather than the center channel, sound field collapse will still occur for listeners that are not situated in or near a central listening location.

For listeners seated off-center, a mix with vocal signals only in the center loudspeaker will impart an aural image of the vocal signals closest to center of the soundstage independent of listener location. As the center channel is used proportionally less, the vocal image shifts towards the listener's location. This is similar to the problem already described for two-channel sources; however, the solution to the problem is complicated by the presence of the center-channel signal. A 5.1 channel program with vocal signals in only the center channel can preserve a central aural image despite listener location and does not need any further modification. A program that uses only the L and R channels has the same limitations as standard two-channel recordings, and programs that place vocal signals into the L, C and R channels will produce central aural images having locational stability somewhere between that provided by these two extremes. The end result is that current mixing techniques do not assure consistent vocal imaging results for all listener locations. This is sometimes a problem for listeners at home, but it is almost always a problem for listeners in cars because typically no listener is centrally located relative to the loudspeakers.

### DISCLOSURE OF INVENTION

The present invention overcomes these problems.

According to one aspect of the present invention, an audio decoder comprises a plurality of input signal paths including a first input signal path that conveys a left-channel input signal, a second input signal path that conveys a right-channel input signal and a third input signal path that conveys a center-channel input signal; a signal processor having inputs coupled to the first and second input signal paths and having a plurality of outputs that provides processed signals derived from the left-channel and right-channel input signals, wherein a first output provides a left-channel processed signal, a second output provides a right-channel processed signal and a third output provides a center-channel processed signal; a signal combiner having inputs coupled to the third input signal path and the third output of the signal processor, and having an output that provides a signal representing a combination of the center-channel input signal and the center-channel processed signal; and a plurality of output signal paths including a first output signal path coupled to the first output of the signal processor, a second output signal path coupled to the second output of the signal processor and a third output signal path coupled to the output of the signal combiner.

According to another aspect of the present invention, an audio decoder comprises a plurality of input signal paths including a first input signal path that conveys a left-channel input signal, a second input signal path that conveys a right-channel input signal and a third input signal path that conveys a center-channel input signal; a signal processor having inputs coupled to the first, second and third input signal paths and having outputs that provide processed signals derived from a mix of the left-channel and center-channel input signals and a mix of the right-channel and center-channel input signals, wherein a first output provides a left-channel processed signal, a second output provides a right-channel processed signal and a third output provides a center-channel processed signal; a plurality of output signal paths including a first output signal path coupled to the first output of the signal processor, a second output signal path coupled to the second output of the signal processor and a third output signal path coupled to the third output of the signal processor.

According to yet another aspect of the present invention, an audio decoding method comprises receiving a left-channel input signal, a right-channel input signal and a center-channel input signal; deriving from the left-channel and the right-channel input signals a plurality of processed signals that includes a left-channel processed signal, a right-channel processed signal and a center-channel processed signal; combining the center-channel input signal and the center-channel processed signal; and providing a plurality of output signals representing the left-channel processed signal, the right-channel processed signal, and the combined center-channel input signal and center-channel processed signal.

### BRIEF DESCRIPTION OF DRAWINGS

FIG. 1 is a block diagram of a multichannel audio decoder with Surround EX decoding.

FIG. 2 is a block diagram of a multichannel audio decoder that redistributes center channel signals.

FIG. 3 is a block diagram of a multichannel audio decoder with a hybrid discrete/matrix 3-channel processor.

FIG. 4 is a block diagram of an audio decoder for a matrix-enhanced five-channel system.

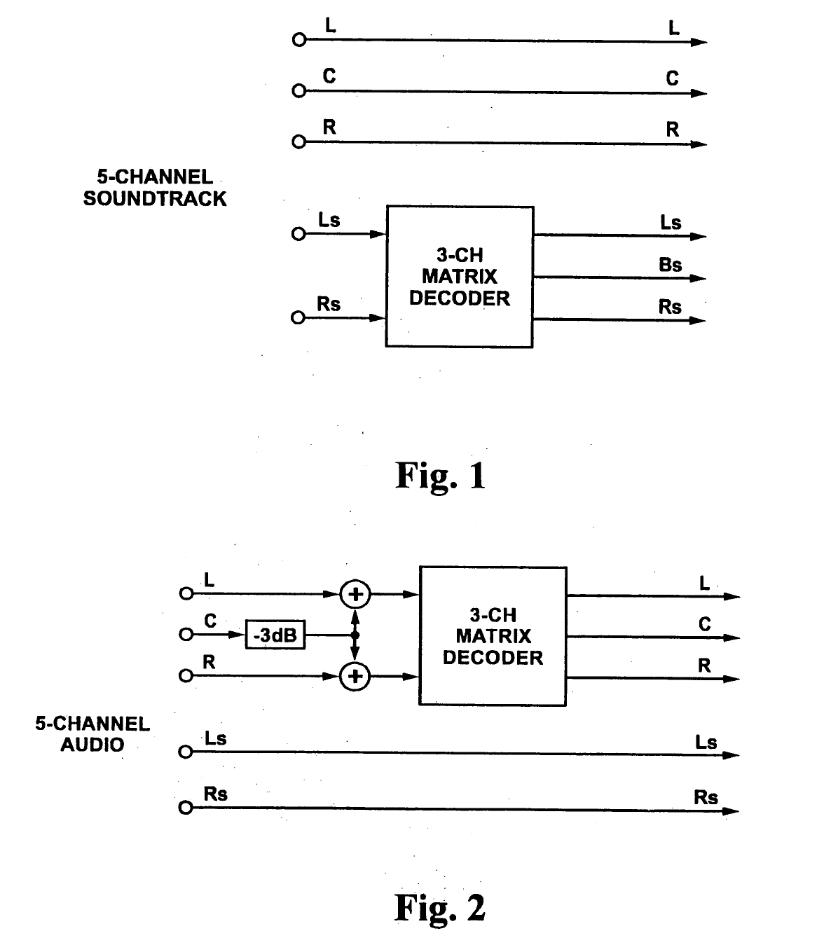

### MODES FOR CARRYING OUT THE INVENTION

More particular mention is made of “vocal signals” and “vocal images” in this disclosure because musical programs of two or more channels typically are designed to present these types of signals at the center of the sound stage. The present invention may be applied to any type of signal and is not limited to vocal signals. References herein to vocal signals and the like should be understood to refer to any type of aural signal that is intended to be presented at or near the center of the soundstage.

One implementation of a system that can provide a stable central aural image is illustrated in FIG. 2. In this implementation, the C channel signal is distributed or mixed into the L and R channels to provide a two-channel signal. The vocal signals pre-existing in the C channel are mixed into both L and R channels at the same level. The resulting two-channel signal is then processed to derive three channels (L, C and R) with a dominant portion of the vocal signals in the C channel, which provides a consistent central aural image using three front loudspeakers.

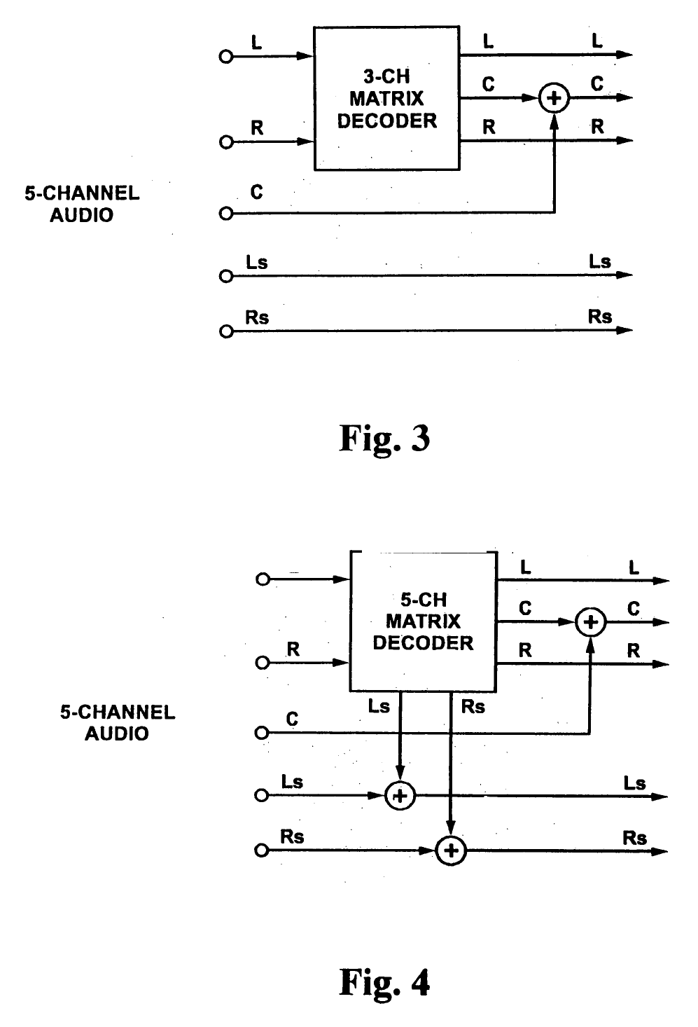

Another implementation of a system that can provide a stable central image is illustrated in FIG. 3. Unlike the first implementation, this second implementation does not mix the C channel signal into the L and R channel signals. Instead, it extracts the vocal signals that are in the L and R channel signals and adds the extracted vocal signals to the C channel signal. As a result, the stability of the vocal image presented by the signal pre-existing in the C channel is not adversely affected and leakage or coupling of the C channel signal into other channels is avoided. This generally provides a cleaner and more stable sound image and better lateral separation of the images produced by the L and R channel signals. If a multi-channel program has no significant signal present in the C channel, this second implementation provides a result that is essentially the same as that provided by the first implementation shown in FIG. 2.

Principles of the present invention may also be applied to other channels. For example, as shown in FIG. 4, a 5-channel decoder derives a C channel signal as discussed above in connection with FIG. 3 and also derives a pair of surround channel signals that are added to the original Ls and Rs channel signals. This technique can be used to enhance the spatial effect of a program without causing any leakage of the original surround channel signals into the front channel signals.

The several figures and associated text omit various aspects that may be important in a practical implementation but are not needed to describe the present invention. For example, an implementation of the decoder component shown in the figures may introduce a phase shift or time delay in the signals that it processes. In such cases, a preferred implementation includes delay elements or other processing components in direct signal paths so that phase shifts and time delays for all channels are identical or substantially identical. Referring to FIG. 4, for example, components that provide an appropriate phase shift or time delay may be inserted into the signal paths for the C, Ls and Rs channels at a point prior to or “upstream” from the summing components.

1. An audio decoder that comprises:
a plurality of input signal paths including a first input signal path that conveys a left-channel input signal, a second input signal path that conveys a right-channel input signal and a third input signal path that conveys a center-channel input signal;
a signal processor having inputs coupled to the first and second input signal paths and having a plurality of outputs that provides processed signals derived from the left-channel and right-channel input signals, wherein a first output provides a left-channel processed signal, a second output provides a right-channel processed signal and a third output provides a center-channel processed signal;
a signal combiner having inputs coupled to the third input signal path and the third output of the signal processor, and having an output that provides a signal representing a combination of the center-channel input signal and the center-channel processed signal; and
a plurality of output signal paths including a first output signal path coupled to the first output of the signal processor, a second output signal path coupled to the second output of the signal processor and a third output signal path coupled to the output of the signal combiner.

2. The decoder of claim 1 wherein the signal processor is implemented by a logic matrix decoder.

3. An audio decoder that comprises:
a plurality of input signal paths including a first input signal path that conveys a left-channel input signal, a second input signal path that conveys a right-channel input signal and a third input signal path that conveys a center-channel input signal;
a signal processor having inputs coupled to the first, second and third input signal paths and having outputs that provide processed signals derived from a mix of the left-channel and center-channel input signals and a mix of the right-channel and center-channel input signals, wherein a first output provides a left-channel processed signal, a second output provides a right-channel processed signal and a third output provides a center-channel processed signal;
a plurality of output signal paths including a first output signal path coupled to the first output of the signal processor, a second output signal path coupled to the second output of the signal processor and a third output signal path coupled to the third output of the signal processor.

4. The decoder of claim 3 wherein the signal processor is implemented by a first signal combiner that provides the mix of the left-channel and center-channel input signals by combining the left-channel and center-channel input signals, a second signal combiner that provides the mix of the right-channel and center-channel input signals by combining the right-channel and center-channel input signals, and a logic matrix decoder having inputs coupled to outputs of the first and second signal combiners.

5. The decoder of any one of claims 1 through 4 wherein:
the plurality of input signal paths includes a fourth input signal path that conveys a surround-channel input signal;
the plurality of signal processor outputs includes a fourth output that provides a surround-channel processed signal;
a surround-channel signal combiner having inputs coupled to the fourth input signal path and the fourth output of the signal processor, and having an output that provides a signal representing a combination of the surround-channel input signal and the surround-channel processed signal; and
the plurality of output signal paths includes a fourth output signal path coupled to the output of the surround-channel signal combiner.

6. An audio decoding method that comprises:
receiving a left-channel input signal, a right-channel input signal and a center-channel input signal;
deriving from the left-channel and the right-channel input signals a plurality of processed signals that includes a left-channel processed signal, a right-channel processed signal and a center-channel processed signal;
combining the center-channel input signal and the center-channel processed signal; and
providing a plurality of output signals representing the left-channel processed signal, the right-channel processed signal, and the combined center-channel input signal and center-channel processed signal.

7. The decoding method of claim 6 wherein the left-channel processed signal, right-channel processed signal and center-channel processed signal are derived by applying a logic matrix decoder to the left-channel and the right-channel input signals.

8. The decoding method of claim 6 or 7 that comprises:
receiving a surround-channel input signal;
deriving from the left-channel and the right-channel input signals a surround-channel processed signal;
combining the surround-channel input signal and the surround-channel processed signal; and
providing an output signal representing the combined surround-channel input signal and surround-channel processed signal.
